(19) United States
(12) Patent Application Publication
(10) Pub. No.: US 2022/0084143 A1
(43) Pub. Date: Mar. 17, 2022

(54) SYSTEMS AND METHODS FOR CREATING CINEMATIC INFOMERCIALS AND FACILITATING REAL-ESTATE TRANSACTIONS

(71) Applicant: BOX OFFICE REALTY SERVICES, LLC, Austin, TX (US)

(72) Inventor: Keith Byer, Austin, TX (US)

(21) Appl. No.: 17/446,582

(22) Filed: Aug. 31, 2021

Related U.S. Application Data
(60) Provisional application No. 63/077,505, filed on Sep. 11, 2020.

(51) Int. Cl. G06Q 50/16; G06Q 30/02

(52) U.S. Cl. CPC G06Q 50/16; G06Q 30/0276; G06Q 30/0277

(57) ABSTRACT

Systems and methods are described for creating cinematic infomercials and facilitating real estate transactions. A system receives sell interest for a property from a seller, receives a story from the owner of a real estate property, collects images and 360-degree videos of the interior and exterior of the property captured through a drone, geotags location of the property, collects neighborhoods information, and create a cinematic infomercial for the property and the environment around using a machine-assisted media editing tool. The cinematic infomercial includes a voice-over narrated story synced with 360 videos. The system facilitates the listing of the property on an online portal that allows a potential buyer to view more than 80 critical points of the property and environment around with the help of cinematic infomercial and make a buying decision. The system allows different stack holder to provide other allied services to interact through the online portal and complete the real estate transaction.

### PRIORITY

This application claims priority to U.S. Provisional Patent Application No. 63/077,505 filed Sep. 11, 2020, and entitled “SYSTEMS AND METHODS FOR CREATING CINEMATIC INFOMERCIALS AND FACILITATING REAL-ESTATE TRANSACTIONS,” which application is incorporated herein by reference.

### FIELD OF THE PRESENT DISCLOSURE

Embodiments of the present invention generally relate to online real-estate transaction platforms. In particular, embodiments of the present invention relate to a platform for creating cinematic infomercials and facilitating real estate transactions.

### BACKGROUND OF THE DISCLOSURE

Real estate transactions have gained an important place in the economy due to its immense contribution to Gross Domestic Product (GDP). In a single year, for example, in 2018 alone, the real estate industry was USD 3 trillion. Although many efforts are made to simplify the process, real estate transactions are still one of the time consuming and complex transactions. Typical real estate transactions involve multiple parties, such as sellers, real estate agencies, buyers, financial institutions, builders, contractors, interior designers, lawyers, title companies, and government institutions. For a single transaction to complete, many parties have to do their job correctly and are required to be in sync. A seller has to first list a property for sale by creating online or print media ads. A buyer needs to schedule a time to visit the property with the help of the seller or an authorized real estate agency, visit the property at the scheduled time, get legal clearance with the help of a lawyer, process a loan document, and complete the title transfer process.

The decision of a buyer depends on many factors, such as the interior of the property, exterior of the property, neighborhood, places of interest for the buyer, proximity of academic institution, hospital, government establishments, etc. Even after visiting the property, a buyer needs to consider many such factors before finalizing the decision. Once a buyer decides to buy the property, he/she may need a lawyer for legal verification, banking institutions for loan or mortgage, a contractor for remodeling, and other such parties.

There is an inherent inefficiency in each of these steps. To overcome these efficiencies, companies in the past have come up with online portals for facilitating real estate transactions. These portals allow sellers or their authorized real estate agencies to post advertisement online regarding the availability of a property, and enable buyers to search property of their choice using multi-filter search interfaces. Listing of properties on these portals is limited to images or traditional videos that do not provide all necessary information required to make a buying decision. Visiting property with a real estate agency is also a very time-consuming affair.

Some of these portals also assist in legal verification, financial, and other such task requiring different professionals or experts. A user may have to use different online platforms for various activities related to real estate transactions. Users may have to visit a platform for searching the property, another venue for exploring the neighborhood, yet another platform for engaging with different professionals and institutions.

Therefore, there exists a need for an integrated platform for the better posting of real estate advertisements and facilitating real estate transactions requiring the involvement of multiple parties.

### BRIEF SUMMARY OF THE DISCLOSURE

Systems and methods are described for creating cinematic infomercials and facilitating real estate transactions. According to an embodiment, a system allows the creation of a cinematic infomercial related to real estate and facilitates real estate transactions through an integrated platform engaging different stack holders. A cinematic infomercial creation module of the system may receive a story from the owner of a real estate property, collect images and 360° videos of the interior and exterior of the property captured through a drone, geotag the location of the property, collect neighborhoods information, and create a cinematic infomercial for the property using a machine-assisted media editing tool. In an embodiment, the 360-degree videos of the interior and exterior of the property captured through a drone may include a video of a person or simulated character navigating the property and environment around.

The cinematic infomercial may include a narrated story synced with different parts of the property with the 360-degree video. In an embodiment, a story received from the owner of the property may be narrated by the owner or may be narrated in a system modulated voice or by a second person (e.g., a known actor/actress or known personality). As one may appreciate, the cinematic infomercial is not only about the property in question but also about the environment around the property, as that is what influences a buyer a lot when it comes to making buying a property.

In an embodiment, on request of an owner or an authorized representative of the property, a cinematic infomercial creation module may dispatch a drone to the location of the property, guide the drone from a remote location to capture 360-degree video of the interior and exterior of the property, and capture 360-degree neighborhoods view. The cinematic infomercial creation module may check flying clearance around the property clearance by invoking APIs provided for the purpose (e.g., through DJI App or Kittyhawk App) before dispatching the drone. The drone may offload the captured 360 videos to a cloud-based database. The cinematic information creation module may receive a raw story or scripted story in the form of text or audio file recording through a portable device from the owner of the property. The portable device may also upload the raw story or scripted story to the cloud database. The cinematic infomercial creation module may further collect a music matching type of property and facilitate the creation of cinematic infomercial with the help of a machine-assisted editorial tool. The cinematic infomercial creation modules allow stitching together the 360-degree videos, scripted stories received from the owner, its narrated version, the geotagged location, neighborhood information, and other metadata. In an embodiment, the other metadata may include information about neighbors, neighborhoods, schools, restaurants, key landmarks, and other such information. In an embodiment, the system captures more than 80 critical points of the property and the environment around, to facilitate remote buying decision.

The system facilitates the listing of the property along with the created cinematic infomercials on an online portal. The system allows potential buyers to search for a property using multiple filters and providing his preferences. The system allows a potential buyer to view the cinematic infomercial with the help of interaction engagement options through the online portal using a web browser or a mobile application. The system allows the potential buyers to view the 360-degree video of the property and its neighborhoods, explore map leading to the property, see an aerial view of the surrounding, and explore the area of user's interest such as schools, colleges, commercial spaces, recreation centers, shopping centers, Banks, Hospitals, Hotels, Restaurants, pharmacy, law enforcement agencies, important government establishments, etc. in the surrounding through an integrated map. In an embodiment, the system may also show influencer neighbors, past criminal records on the neighborhood, and clearness index of the proximity.

The system further facilitates other allied services, such as the service of lawyers, financial institutions, contractors, interior designers, Government institutions, title companies, etc. through the online portal. The system allows listing of properties and also brings all parties of the transaction together at one simple easy to use online portal.

The system enables a prospective buyer to make a remote buying decision through the online platform. In an embodiment, the system allows the broadcasting or sharing of cinematic infomercial through multiple media outlets or social networking platforms.

In an embodiment, the system may dispatch a drone to a property of the user's interest and allow the user to navigate the drone from a remote location to capture and display a live feed from the property and environment around. The system, through an interactive user interface, may allow the user to explore more than 80 critical points related to the properties from different angles. In an embodiment, the system may recommend missing view or critical points if the user has not yet explored those critical points and views.

### BRIEF DESCRIPTION OF THE DRAWINGS

The present subject matter will now be described in detail with reference to the drawings, which are provided as illustrative examples of the subject matter as to enable those skilled in the art to practice the subject matter. It will be noted that throughout the appended drawings, like features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates a network arrangement for creating cinematic infomercial and enabling online real estate transaction in accordance with an embodiment of the present disclosure.

FIG. 2 is a block diagram illustrating different stack holders who can engage with a real estate transaction facilitation platform to complete a real estate transaction in accordance with an embodiment of the present disclosure.

FIG. 3A shows a generalized embodiment of an exemplary computing device through which different stack holders can engage to complete real estate transactions in accordance with an embodiment of the present disclosure.

FIG. 3B is a block diagram illustrating the component of a mobile device through which different stack holders can engage to complete real estate transactions in accordance with an embodiment of the present disclosure.

FIG. 4 illustrates the functional modules of a real estate transaction facilitation system in accordance with an embodiment of the present disclosure.

FIG. 5 illustrates the function sub-modules of a cinematic infomercial creation module in accordance with an embodiment of the present disclosure.

FIG. 6 illustrates the components of cinematic infomercial created in accordance with an embodiment of the present disclosure.

FIG. 7 illustrates an example computing device and user interface to present a property listing in accordance with an embodiment of the present disclosure.

FIG. 8 illustrates an example user interface listing property with cinematic infomercial in accordance with an embodiment of the present disclosure.

FIG. 9 illustrates an example map showing property and its neighborhood in accordance with an embodiment of the present disclosure.

FIG. 10 illustrates an exemplary computer system in which or with which embodiments of the present invention may be utilized.

### DETAILED DESCRIPTION OF THE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and human operators.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “network resource” generally refers to various forms of data, information, services, applications and/or hardware devices that may be accessed via a network (e.g., the Internet). Non-limiting examples of network resources include web applications, cloud-based services, network devices and/or associated applications (e.g., user interface applications) and network security devices and/or associated applications (e.g., user interface applications). Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

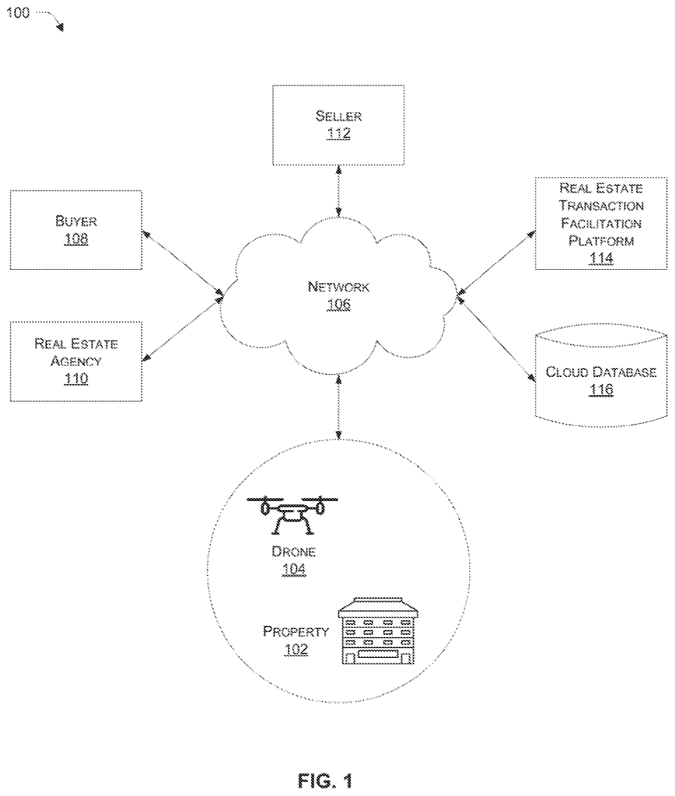

FIG. 1 illustrates a network arrangement for creating cinematic infomercial and enabling online real estate transaction in accordance with an embodiment of the present disclosure. As shown in FIG. 1, real estate transaction facilitation platform 114 that allows the creation of a cinematic infomercial and facilitate real estate transaction online. Real estate transactions facilitation platform 114 is designed and created to give both buyers and sellers of real estate enhanced way to show or view properties, and also bring all parties of the transaction together at one simple easy to use web portal. Real estate transaction facilitation platform 114 allows listing a property with cinematic infomercial that will teleport a prospective buyer from their current world to the one they will soon live within. Real estate transaction facilitation platform 114 allows agents or sellers to qualify buyers before showing a property to decrease the chances of unnecessary viewings, saving agents' significant time. The real estate transaction facilitation platform 114 eliminates the need for potential buyers and sellers to visit a property through the use of virtual touring. Real estate transaction facilitation platform 114 would allow almost all the tractions related to selling and buying a property to be completed online.

Platform 114 allows the creation of cinematic infomercials that helps a prospective buyer to view not only the property of their interest but more about the environment, ecology, and neighborhood of the property. The platform 114 streamlines the buyers' search criteria of interest, shows property listing, and allows the potential buyer to navigate the property and the environment around virtually. The platform may highlight the environment and neighborhood information in more detail, depending on the exposure of the neighborhood to the potential buyer based on his past profile. If a potential buyer doesn't know the area, platform 114 may show more details about the town, locality, and neighborhood. Our all-encompassing cinematic infomercial eliminates the tire kicking. As one may appreciate, platform 114 provides not only a detailed view of the property people but also the environment around, which in many cases might be more important to a potential buyer.

Platform 114 helps seller 112 or real estate agency 110 to list property 102 for sale. On receipt of selling interest, platform 114 may initiate the property listing process by collecting the basic details of the property through an online portal and creating a cinematic infomercial for property 102. platform 114 may receive basic details including of expectation of the seller, location of the property, target buyers group, title documents, etc. Platform 114 may use media capturing devices, autonomous vehicle-mounted cameras, drone 104 equipped with camera, and local computing infrastructure (e.g., mobile, tablet, laptop, etc.) to capture high-quality images (e.g., 4k, 6k, 8k resolution) and 360 videos of property 102. Images or videos captured by different cameras can be uploaded to a cloud database 116 with the help of local computing infrastructure. The local computing infrastructure may collect images and 360 videos from cameras through a short-range wireless communication medium or using the physical memory transfer, and uploads the collected images and videos to cloud database 116 through network 106. The drone or image capturing devices can capture more than 80 critical points of property 102 and the environment around. Platform 114 facilitates the creation of cinematic infomercial using these high-quality images and 360 video contents.

Platform 114, similarly for each property, collects basic details from the seller and creates cinematic infomercial and stores those in cloud database 116. The cloud database 116 maintains a dynamically updated list of properties available for sell. Platform 114 lists these properties accessible to a potential buyer through a web browser interface or mobile App or TV App. The platform allows a potential from the comfort of their home to search properties of their interest and know in and out of a property and its surrounding. The platform enables a potential buyer to remotely view more than 80 critical points of the property and the environment around. By the time a buyer has walked through details of the property with the help of the cinematic infomercial, a user may have 80+ critical pieces of information they will need and rely on to make a buying decision. From the comfort of their home or office, buyers can see not only the inside and outside of the featured property but also the entire ecosystem that surrounds it. Platform 114 provides information on the neighborhood, community, shopping centers, schools, restaurants, as well as recreational activities like nearby lakes, golf courses, and other vital landmarks.

Platform 114 offers business continuity of real estate transactions even in situations when physical intersections are restricted (for example, during physical movement restriction imposed during the COVID-19 global pandemic). Platform 114 provides a virtual tour through the use of cinematic infomercial and further facilitates the engagement of other professions and services required to complete real transactions.

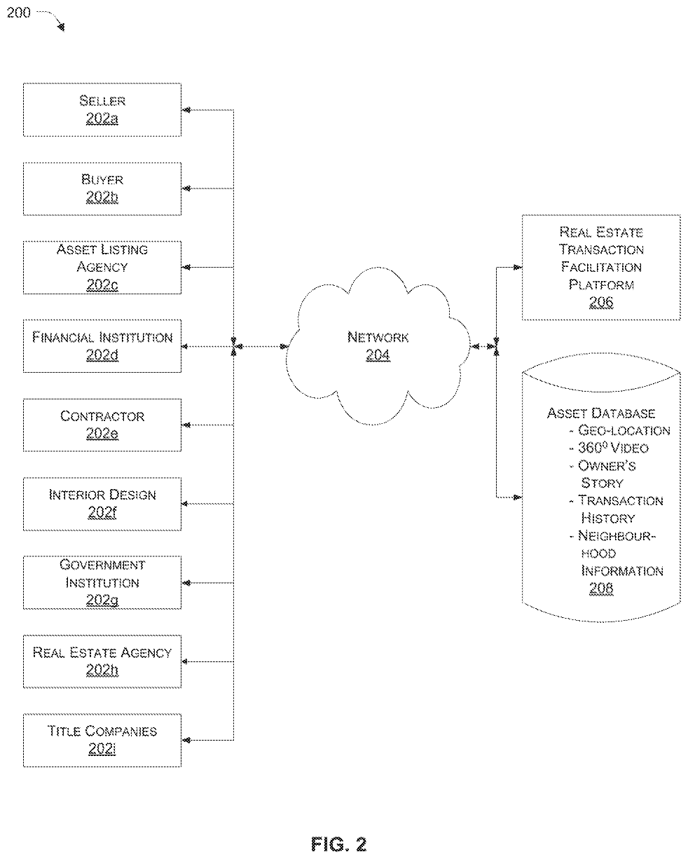

FIG. 2 is a block diagram illustrating different stack holders who can engage with a real estate transaction facilitation platform to complete a real estate transaction in accordance with an embodiment of the present disclosure. The real estate transaction facilitation platform 206 (same as platform 114) allows different stack holders 202a-i to interact and complete real estate transactions. The stack holders 202a-i may connect through network 204 (e.g., Internet) to list a property, create cinematic infomercials, view the property, take a virtual tour using the cinematic infomercials, and complete the transaction without or with minimal need of physical visits. Different stack holders 202a-i that the platform 206 allows to interact include but are not limited to, for example, seller 202a, buyer 202b, asset listing agency 202c, financial institution 202d, contractor 202e, interior designer 202f, government institution 202g, real estate agency 202h and title companies 202i. Platform 206 stores in cloud database 208 for each property, a set of essential and auxiliary information. Each property, the platform may collect, store, and maintain geo-location, 360-degree video of the property and the environment around, the owner's story, past transaction history, and neighborhood information.

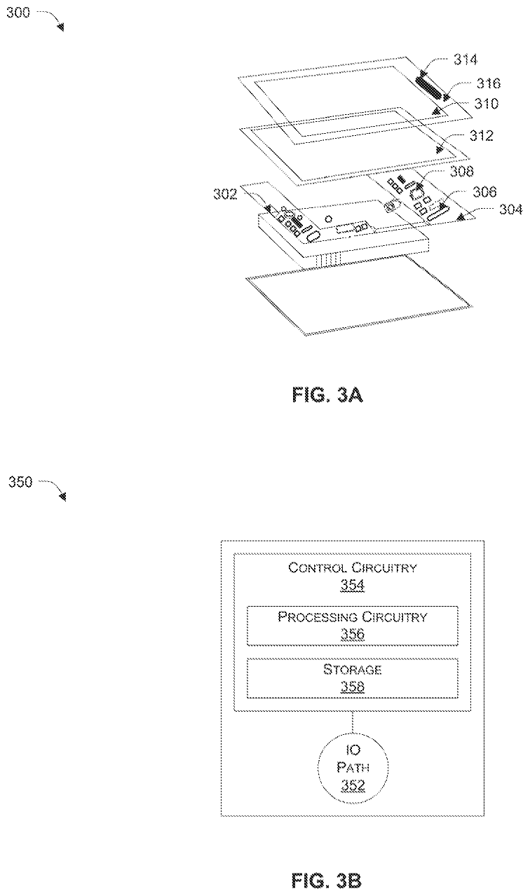

FIG. 3A shows a generalized embodiment of exemplary computing device 300 through which different stack holders can engage to complete real estate transactions in accordance with an embodiment of the present disclosure. As depicted, computing device 300 may be a smartphone or tablet. The computing device 300 may receive content and data via input/output (hereinafter “I/O”) path 302. I/O path 302 may provide metadata, voice profiles, and/or voice clips to control circuitry 304, which includes processing circuitry 306 and storage 308. Control circuitry 304 may send and receive commands, requests, and other suitable data using I/O path 302. I/O path 302 may connect control circuitry 304 (and specifically the processing circuitry 306) to one or more communications paths (described below). I/O functions may be provided by one or more of these communications paths, but are shown as a single path in FIG. 3A to avoid overcomplicating the drawing.

Control circuitry 304 may be based on any suitable processing circuitry, such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, Hexa-core, or any suitable number of cores) or supercomputer. In some embodiments, the processing circuitry is distributed across multiple separate processors or processing units of different types, for example, multiple of the same type of processing units (e.g., two Intel Core i7 processors) or multiple different processors (e.g., an Intel Core i5 processor and an Intel Core i7 processor).

In some embodiments, control circuitry 304 executes instructions for facilitating real estate transactions stored in memory (i.e., storage 308). Specifically, control circuitry 304 may be instructed to perform searching processing, retrieve data and/or voice profiles or voice clips, and/or perform the other functions discussed above and below.

In client/server-based embodiments, the control circuitry 304 includes communications circuitry suitable for communicating with a real estate transaction facilitation platform or other networks or servers. The instructions for carrying out the above-mentioned functionality may be stored on a server or a cloud database. Communications circuitry may include a cable modem, integrated services digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of client devices or communication of media devices in locations remote from each other.

The memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, hard drives, optical drives, solid-state devices, quantum storage devices, or any other suitable fixed or removable storage devices, and/or any combination of the same. Nonvolatile memory may also be used (e.g., to launch a boot-up routine and other instructions). Cloud-based storage, described in relation to FIG. 2, may be used to supplement storage 308 or instead of storage 308.

Control circuitry 304 may include audio processing circuitry and/or audio generation circuitry, other digital encoding or decoding circuitry, or any other suitable audio circuits or combinations of such circuits. Encoding circuitry (e.g., for converting received audio input or digital signals to audio signals for analysis or storage) may also be provided. The audio circuitry may be used by the computing device 300 to receive, process, and generate audio input or output. The circuitry described herein, including, for example, audio generating, encoding, decoding, encrypting, decrypting, and analog/digital circuitry, may be implemented using software running on one or more general-purpose or specialized processors. Multiple circuits may be provided to handle simultaneous processing functions. If storage 308 is provided as a separate device from media device 300, the circuitry may be associated with storage 308.

A user may send instructions to control circuitry 304 using user input interface 310 of computing device 300. The user input interface 310 may be any suitable user interface, such as a remote control, mouse, trackball, keypad, keyboard, touch screen, touchpad, stylus input, joystick, or other user input interfaces. Display 312 may be a touchscreen or touch-sensitive display. In such circumstances, user input interface 310 may be integrated with or combined with display 312. A camera, microphone, or other visual or voice recognition interface may also be used to receive user input (e.g., voice prompts). Speakers 314 may be provided as integrated with other elements of computing device 300.

The interactive application and/or any instructions for performing any of the embodiments discussed herein may be encoded on computer-readable media. Computer-readable media includes any media capable of storing data. In some embodiments, the real estate transaction facilitation application is a client/server-based application. Data for use by a thick or thin client implemented on computing device 300 is retrieved on-demand by issuing requests to a server remote to computing device 300, as described above. For example, computing device 300 may receive inputs from the user via input interface 310 or microphone 316 and transmit those inputs to the remote server (e.g., cloud database 208) for processing and generating the corresponding outputs. The generated output is then transmitted to computing device 300 to be output to the user. Those skilled in the art will appreciate that respective client devices used by different stack holder 202a-i may be implemented as media device 300 of FIG. 3A.

FIG. 3B is a block diagram illustrating the component of a mobile device through which different stack holders can engage to complete real estate transactions in accordance with an embodiment of the present disclosure. The mobile device 350 may receive data related to real estate transactions via an input/output path 352. The I/O path 352 may provide data related to real estate transactions and other required services to control circuitry 354. The control 354 includes a processing circuitry 356 configured to process the data and execute instructions to perform function s of the system 400 described below. The control circuitry 354 includes a storage 358 that stored programmable instructions and other data related to real estate transactions. The control circuitry 354 may send and receive commands, requests, and other suitable data using the I/O path 352. The I/O path 352 may connect the control circuitry 354 to one or more communications paths.

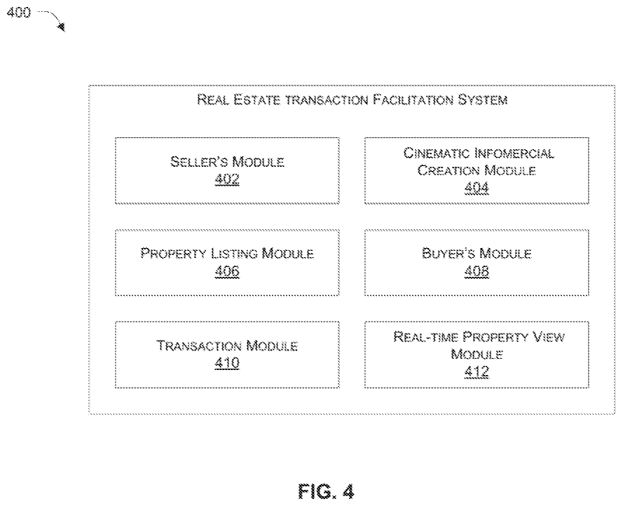

FIG. 4 illustrates the functional modules of real estate transaction facilitation system 400 in accordance with an embodiment of the present disclosure. Real estate transaction facilitation system 400 is implemented through a client-server architecture where a server or cloud base platform stores relevant instructions and data and allows a client application (e.g., web browser, or an app) to interact with the system. Real estate transaction facilitation system 400 (performing similar functions as the real estate transaction facilitation platform 206 or the platform 114) facilitate listing of a property along with a cinematic infomercial on an online portal, listing and completing buy and sell transactions through the online portal accessible through a web browser or mobile app or TV app. System 400 allows the creation of a cinematic infomercial related to real estate and facilitates real estate transactions through the integrated online portal (also referred interchangeably as online platform) engaging different stack holders.

Real estate transaction facilitation system 400 includes seller's module 402 configured to allow a seller or its authorized representative to show their interest to sale a real estate property. Seller's module 402 collects basic details, including but not limited to property ID, location, and relevant documents illustrating ownership about the property from the seller. System 400 includes a cinematic infomercial creation module 404 configured to create a cinematic infomercial for the property. The cinematic infomercial creation module 404 on receipt of basic details of a property from the owner of a real estate property, collects images and 360-degree videos of the interior and exterior of the property captured through a drone, geotags location of the property, collects neighborhoods information, and creates a cinematic infomercial for the property using a machine-assisted media editing tool. In an embodiment, the 360-degree videos of the interior and exterior of the property captured through a drone may include a video of a person or simulated character navigating the property and environment around. The cinematic infomercial may also include narrated voice-over synced with 360-degree video to explain critical features of the property and environment around. In an embodiment, the cinematic infomercial may include a narrated story synced with different parts of the property with the 360-degree video. The story received from the owner of the property may be narrated by the owner or may be narrated in a computer modulated voice or by a second person (e.g., a known actor/actress or known personality). As one may appreciate, the cinematic infomercial is not only about the property in question but also about the environment around the property, as that is what influences a buyer a lot when it comes to making buying decisions.

In an embodiment, Cinematic infomercial creation module 404 to create a cinematic infomercial may dispatch a drone to the location of the property, guide the drone from a remote location to capture 360-degree video of the interior and exterior of the property, and capture 360-degree neighborhoods view. Cinematic infomercial creation module 404 may check flying clearance around the property by invoking APIs provided for the purpose (e.g., through DJI App or Kittyhawk App) before dispatching the drone. The drone may offload the captured 360 videos to a cloud-based database. The cinematic information creation module 404 may receive a raw story or scripted story in the form of text or audio file recording through a portable device from the owner of the property. The portable device may also upload the raw story or scripted story to the cloud database. The cinematic infomercial creation module 404 may further collect music, matching type of property, and facilitate the creation of cinematic infomercial with the help of a machine-assisted editorial tool. The cinematic infomercial creation module 404 allows stitching together the 360-degree videos, scripted stories received from the owner, its narrated version, the geotagged location, neighborhood information, and other metadata. The other metadata may include but are not limited to information about neighbors, neighborhoods, schools, restaurants, key landmarks, and other such information. In an embodiment, the system captures more than 80 critical points of the property and the environment around, in order to facilitate remote buying decision.

System 400 includes property listing module 406 configure to facilitates the listing of the property along with the created cinematic infomercials on an online portal. Property listing module 406 lists properties on an online portal accessible to different stack holders, including seller, buyer, real estate agency, financial institutions, contractors, title companies, etc.

The system further includes buyer's module 408 configured to allow a potential buyer to search for a property using multiple filters and by providing his preferences. The buyer's module 408 allows a potential buyer to view the cinematic infomercial with the help of interaction engagement options through the online portal using a web browser or a mobile application. The buyer's module allows the potential buyers to view 360 videos of the property, a 360-degree view of neighborhoods, a map leading to the property, an aerial view of the surrounding, and explore an area of user's interest such as schools, colleges, commercial spaces, recreation centers, shopping centers, Banks, Hospitals, Hotels, Restaurants, pharmacy, law enforcement agencies, important government establishments, etc. in the surrounding through an integrated map. In an embodiment, system 400 may also show influencer neighbors, past criminal records on the neighborhood, and clearness index of the proximity.

The system further includes transaction module 410 configured to facilitate other allied services, such as service of lawyers, financial institutions, contractors, interior designers, Government institutions, title companies, etc. through the online portal to complete buy and sell transactions related to the listed property. System 400 allows listing of properties and also brings all parties of the transaction together at one simple easy to use online portal.

System 400 enables a prospective buyer to make a remote buying decision through the online platform. In an embodiment, system 400 allows the broadcasting or sharing of cinematic infomercial through multiple media outlets or social networking platforms.

In an embodiment, system 400 may include a real-time property view module 412 configured to allow an interested person to view the property on request. The real-time property view module 412, on a request to view a property in real-time, may dispatch a drone and associated infrastructure toward the property of user's interest, and allow the user to navigate the drone from a remote location to capture and display the live feed in real-time from the property and environment around. System 400, through an interactive user interface, may allow the user to explore more than 80 critical points related to the properties from different angles.

In an embodiment, System 400 may recommend a user missing views or critical points if the user has not yet explored those critical points and views.

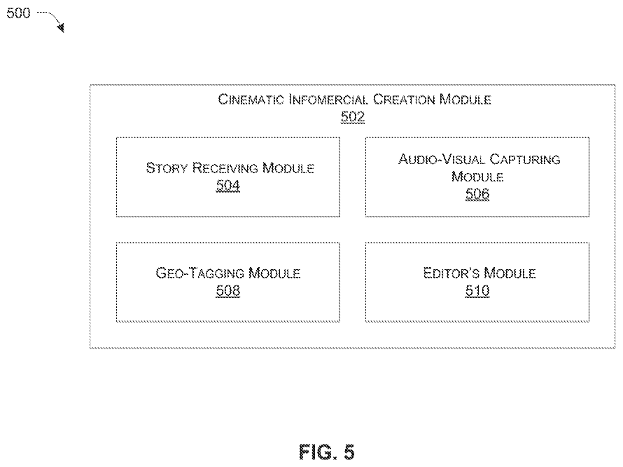

FIG. 5 illustrates function sub-modules of a cinematic infomercial creation module in accordance with an embodiment of the present disclosure. As shown in FIG. 5, cinematic infomercial creation module 502 (same as module 404) includes story received module 504 configured to receive a raw story or scripted story from an owner, and an audio-visual module 504 configured to receive narrated audio from the owner or a professional narrator and receive 360-degree videos from a drone or other imaging devices. The audio-visual module 504 may receive high-quality 360-degree videos and images of the property and the environment around. The cinematic infomercial creation module 500 further includes a geotagging module 508 configured to tag location information with each image and video. Cinematic infomercial creation module 500 further includes editor's module 510 configured to present the script, narrator audio, and the captured image a 360-degree video to a machine-assisted media editing tool. The editing tool allows a user to perform editing of media contents and sync narrated audio with video frames in the right sequence to convey the scripted story and create the cinematic infomercial.

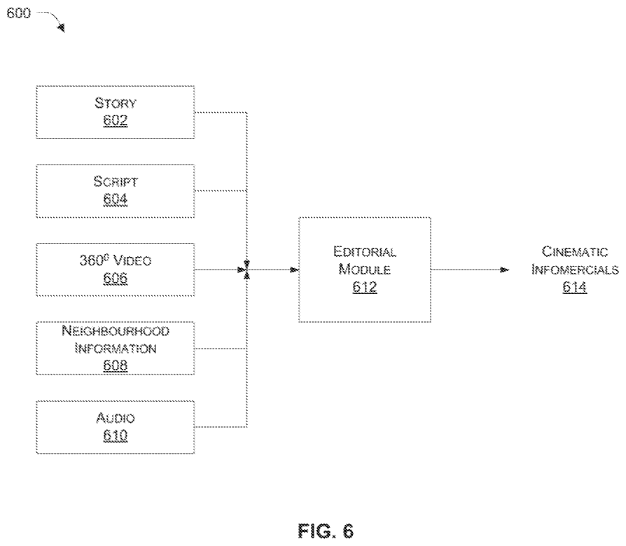

FIG. 6 illustrates the components of cinematic infomercial created in accordance with an embodiment of the present disclosure. As shown in FIG. 6, the editorial module 612 may receive story 602, script 604, 360-degree video 606, neighborhood information 608, and narrated audio 610 and, with the help of man and machine, create the cinematic infomercial 614.

System 400 may facilitate sharing of cinematic infomercial 614 to other social media platforms, such as Facebook and Instagram. Cinematic infomercial 614 can be shared on other property listing platforms.

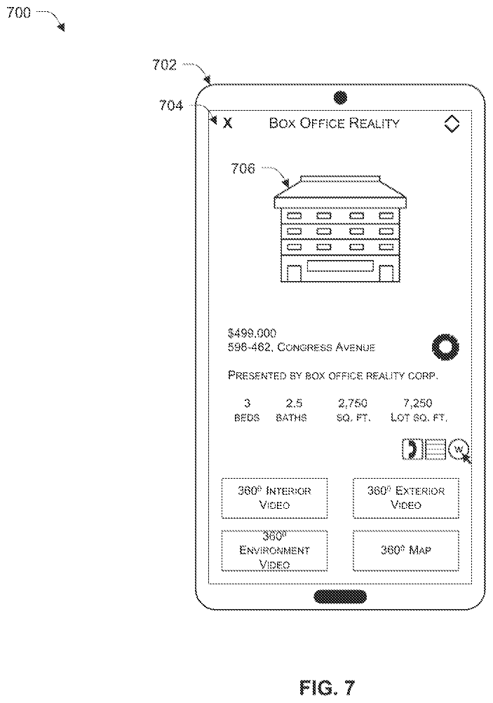

FIG. 7 illustrates an example computing device and user interface to present a property listing in accordance with an embodiment of the present disclosure. A computing device, for example, mobile phone 702 having mobile app 704 (e.g., Box office realty App), may present property 706 with basic details and allow the user to explore cinematic infomercial. Application 704 may allow the user to selectively view particular segments of cinematic infomercial using different selectable user options. The selectable user options are an option to explore 360° interior videos, an option to view 360 exterior videos, an option to view a 360-degree video of the environment, and an option to view 360-degree maps.

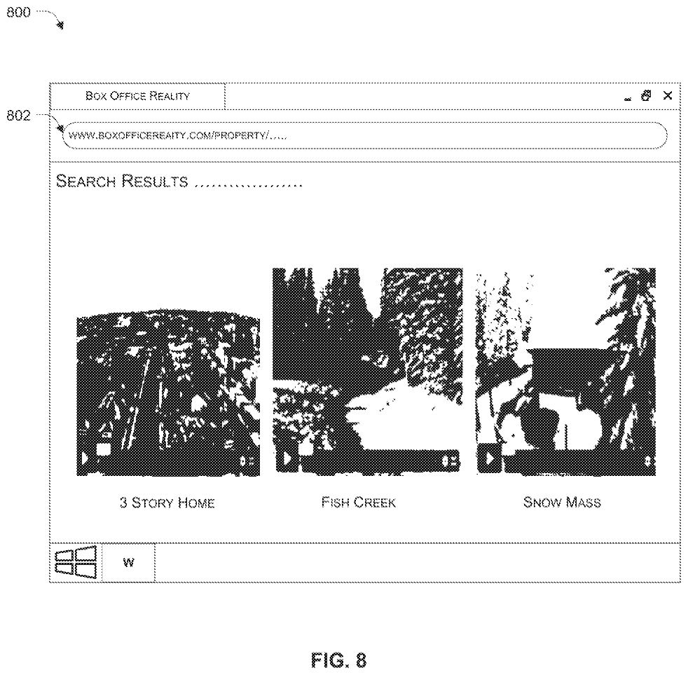

FIG. 8 illustrates an example user interface listing properties with cinematic infomercial in accordance with an embodiment of the present disclosure. As shown in FIG. 8, web browser 802 can be used to access the online listing of property and explore the cinematic infomercial. A user can search for property of their interest, select a particular property to further explore in more detail, and complete all transactions related to the transfer of ownership through the online portal.

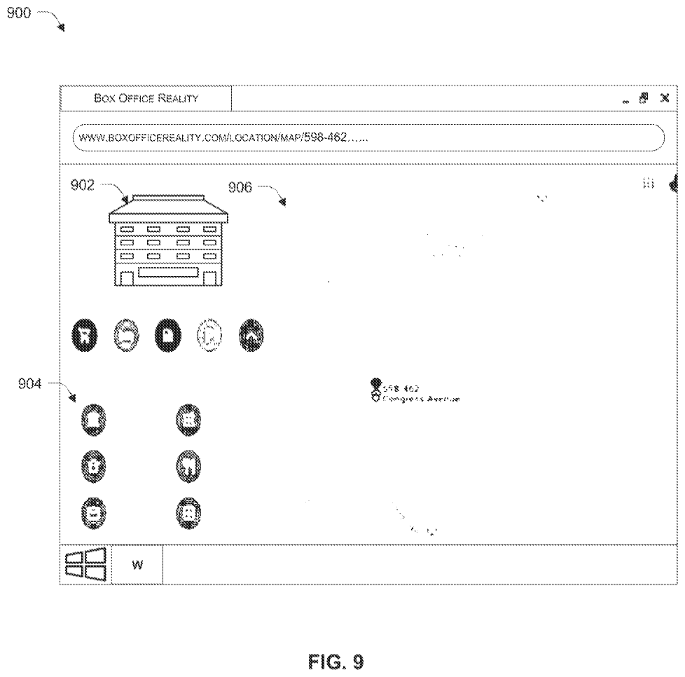

FIG. 9 illustrates an example map showing property and its neighborhood in accordance with an embodiment of the present disclosure. As shown in FIG. 9, the online portal may allow the user to explore property 902 and places of interest over map 906. The portal may enable the user to select options 904 to see banks, pharmacy, takeout outlets, restaurants, post offices, hospitals, hotels, grocery stores, gas stations, recreational places, etc. around the property. The user may select one or more places of interest, and the same may be highlighted over a map.

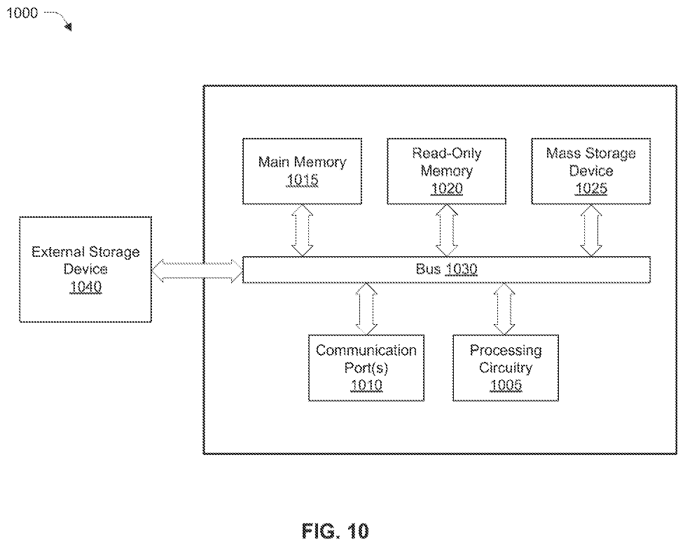

FIG. 10 illustrates an exemplary computer system in which or with which embodiments of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction. As shown in FIG. 10, the computer system includes external storage device 1010, bus 1020, main memory 1030, read-only memory 1040, mass storage device 1050, communication port 1060, and processor 1070.

Those skilled in the art will appreciate that computer system 1000 may include more than one processing circuitry 1070 and communication ports 1060. Processing circuitry 1070 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, Hexa-core, or any suitable number of cores) or supercomputer. In some embodiments, processing circuitry 1070 is distributed across multiple separate processors or processing units, for example, multiple of the same type of processing units (e.g., two Intel Core i7 processors) or multiple different processors (e.g., an Intel Core i5 processor and an Intel Core i7 processor). Examples of processing circuitry 1070 include, but are not limited to, an Intel® Itanium® or Itanium 2 processor(s), or AMD® Opteron® or Athlon MP® processor(s), Motorola® lines of processors, System on Chip (SoC) processors or other future processors. Processing circuitry 1070 may include various modules associated with embodiments of the present invention.

Communication port 1060 may include a cable modem, integrated services digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. Communication port 1060 can be any of an RS-232 port for use with a modem-based dialup connection, a 10/100 Ethernet port, a Gigabit or 10 Gigabit port using copper or fiber, a serial port, a parallel port, or other existing or future ports. Communication port 1060 may be chosen depending on a network, such as a Local Area Network (LAN), Wide Area Network (WAN), or any network to which the computer system connects.

Memory 1030 may include Random Access Memory (RAM) or any other dynamic storage device commonly known in the art. Read-only memory 1040 can be any static storage device(s), e.g., but not limited to, a Programmable Read-Only Memory (PROM) chips for storing static information, e.g., start-up or BIOS instructions for processing circuitry 1070.

Mass storage 1050 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) 10 recorders, BLU-RAY 3D disc recorders, digital video recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement storage memory 1030. Memory 1050 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

Bus 1020 communicatively couples processor(s) 1070 with the other memory, storage, and communication blocks. Bus 1020 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1070 to the software system.

Optionally, operator and administrative interfaces, e.g., a display, keyboard, and a cursor control device, may also be coupled to bus 1020 to support direct operator interaction with the computer system. Other operator and administrative interfaces can be provided through network connections connected through communication port 1060. External storage device 1010 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

Computer system 1000 may be accessed through a user interface. The user interface application may be implemented using any suitable architecture. For example, it may be a stand-alone application wholly implemented on computer system 1000. The user interfaces application and/or any instructions for performing any of the embodiments discussed herein may be encoded on computer-readable media. Computer-readable media includes any media capable of storing data. In some embodiments, the user interface application is a client-server based application. Data for use by a thick or thin client implemented on electronic device computer system 1000 is retrieved on-demand by issuing requests to a server remote to the computer system 1000. For example, computing device 1000 may receive inputs from the user via an input interface and transmit those inputs to the remote server for processing and generating the corresponding outputs. The generated output is then transmitted to computer device 1000 for presentation to the user.

While embodiments of the present invention have been illustrated and described, it will be clear that the invention is not limited to these embodiments only. Numerous modifications, changes, variations, substitutions, and equivalents, will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

What is claimed:

1. An electronic platform for creating cinematic infomercials and facilitating real estate transactions.
